(19) United States
(12) Patent Application Publication
(10) Pub. No.: US 2026/0270911 A1
(43) Pub. Date: Sep. 10, 2026

(54) TA MANAGEMENT OF A SERVING CELL CONFIGURED WITH TWO TIMING ADVANCE GROUPS

(71) Applicant: Lenovo (Beijing) Limited, Beijing (CN)

(72) Inventors: Bingchao Liu, Beijing (CN); Lianhai Wu, Beijing (CN); Ran Yue, Beijing (CN)

(73) Assignee: Lenovo (Beijing) Limited, Beijing (CN)

(21) Appl. No.: 19/164,150

(22) PCT Filed: Jul. 10, 2023
(86) PCT No.: PCT/CN2023/106480

§ 371 Date: Sep. 10, 2025

(51) Int. Cl. H04W 56/00; H04B 7/06; H04L 1/1812; H04W 72/231; H04W 76/30

(52) U.S. Cl. CPC H04W 56/0045; H04B 7/0626; H04B 7/06968; H04L 1/1812; H04W 72/231; H04W 76/30

(57) ABSTRACT

Various aspects of the present disclosure relate to methods and apparatus that support TA management of a serving cell with multiple transmission reception points (TRPs). The apparatus includes a user equipment (UE) for wireless communication, comprising: at least one memory; and at least one processor coupled with the at least one memory and configured to cause the UE to: stop uplink (UL) and downlink (DL) transmission associated with at least one TAG associated with serving cells if TA timer(s) associated with at least one TAG expires.

### TECHNICAL FIELD

The present disclosure relates to wireless communications, and more specifically to timing advance (TA) management of a serving cell with multiple transmission reception points (TRPs).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Multiple TRP (multi-TRP) operation in a serving cell has been specified from NR Release 16. To support more realistically transmission in multi-TRP scenario, each TRP can have its own TA for TRP-specific UL transmission. For example, two TA groups (TAGs) are configured for a serving cell with multiple (e.g., two) TRPs. In addition, two TA timers (TATs) are configured for the serving cell configured with two TAGs.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support TA management of a serving cell with multiple TRPs (e.g., two TRPs).

Some implementations of the method and apparatuses described herein may include a user equipment (UE) for wireless communication, comprising: at least one memory; and at least one processor coupled with the at least one memory and configured to cause the UE to: stop uplink (UL) and downlink (DL) transmission associated with at least one TAG associated with serving cells if TA timer(s) associated with at least one TAG expires.

In some implementations of the method and apparatuses described herein, the at least one processor is further configured to cause the UE to: associate the UL and DL transmission with one of two TAGs associated with a serving cell.

Some implementations of the method and apparatuses described herein may include a processor in a UE for wireless communication, comprising: at least one controller coupled with at least one memory and configured to cause the processor to: stop UL and DL transmission associated with at least one TAG associated with serving cells if TA timer(s) associated with at least one TAG expires.

Some implementations of the method and apparatuses described herein may include a method performed by a user equipment (UE), the method comprising: stopping UL and DL transmission associated with at least one TAG associated with serving cells if TA timer(s) associated with at least one TAG expires.

Some implementations of the method and apparatuses described herein may include at least one memory; and at least one processor coupled with the at least one memory and configured to cause the base station to: stop UL and DL transmission associated with at least one TAG associated with serving cells if TA timer(s) associated with at least one TAG expires.

### BRIEF DESCRIPTION OF THE DRAWINGS

FIG. 1 illustrates an example of a wireless communications system in accordance with aspects of the present disclosure.

FIG. 2 illustrates an example of a user equipment (UE) 200 in accordance with aspects of the present disclosure.

FIG. 3 illustrates an example of a processor 300 in accordance with aspects of the present disclosure.

FIG. 4 illustrates an example of a network equipment (NE) 400 in accordance with aspects of the present disclosure.

FIG. 5 illustrates a flowchart of method performed by a UE in accordance with aspects of the present disclosure.

FIG. 6 illustrates a flowchart of method performed by a NE in accordance with aspects of the present disclosure.

### DETAILED DESCRIPTION

Aspects of the present disclosure are described in the context of a wireless communications system.

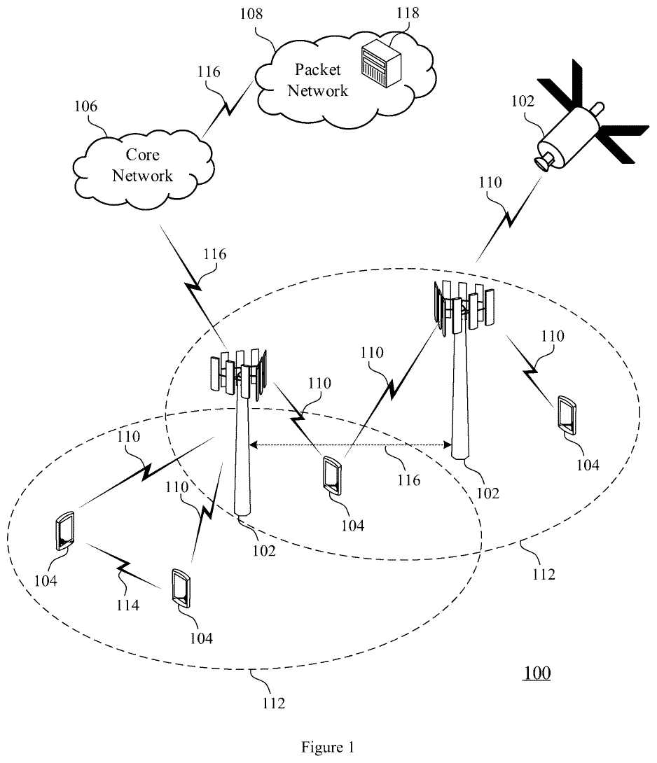

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE (Long Term Evoluation) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link 110, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links 116 (e.g., S1, N2, N2, or network interface). The network entities 102 may communicate with each other over the backhaul links 116 (e.g., via an X2, Xn, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network 108 over one or more backhaul links (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the CN 106 via an NE 102. The CN 106 may route traffic (e.g., control information, data, and the like) between the UE 104 and the application server 118 using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

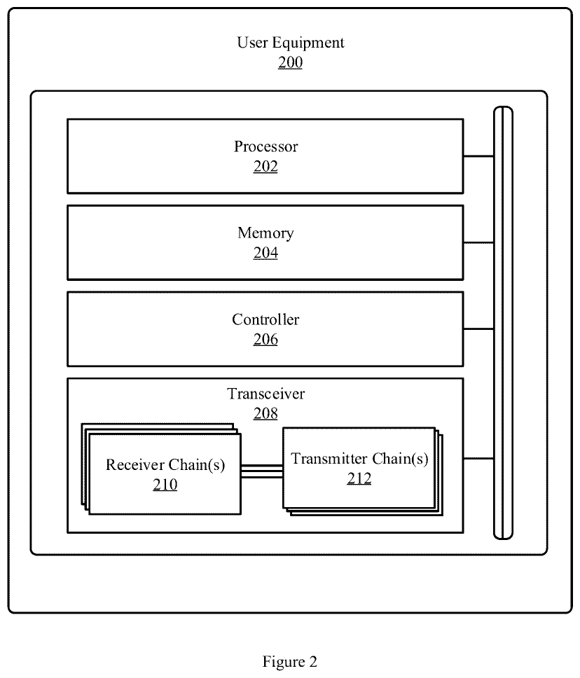

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

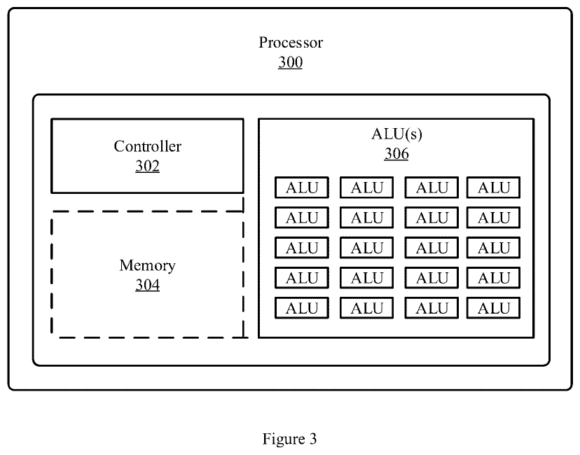

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

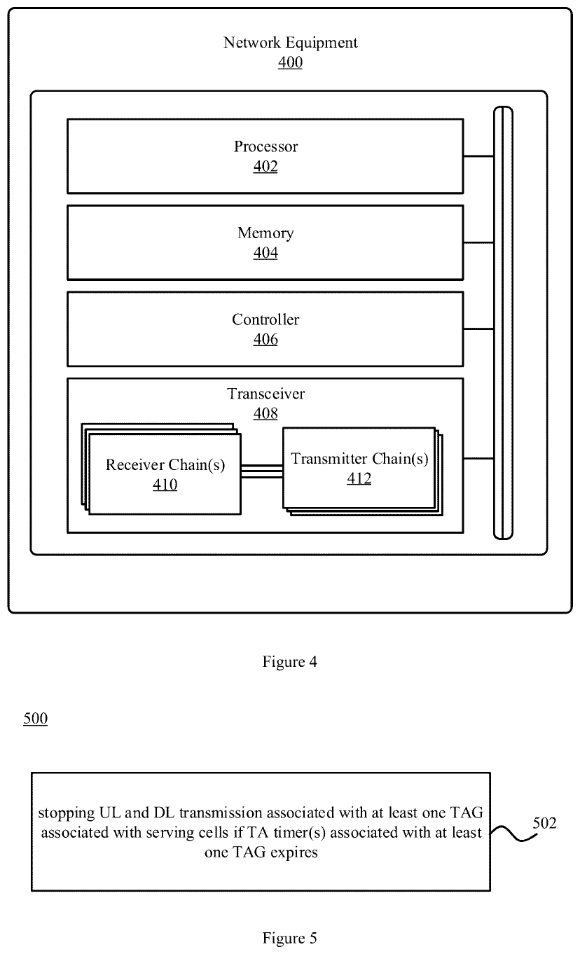

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for determining that a Physical Uplink Shared Channel (PUSCH) transmission is associated with a plurality of Phase-Tracking Reference Signal (PTRS) ports; and receiving the PUSCH transmission together with the plurality of PTRS ports.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

When a serving cell has multiple (e.g., two) TRPs, a separate TAG is associated with each TRP of the serving cell. Each TAG has a TA value and is associated with a TAT. When the TAT associated with a TAG expires, the TA (i.e., TA value) becomes invalid. The following aspects related to uplink (UL) and downlink (DL) transmissions will be impacted when a TAT expires: Hybrid Automatic Repeat Request (HARQ) buffers for one or more serving cells, Physical Uplink Control Channel (PUCCH) on one or more serving cells, Sounding Reference Signal (SRS) on one or more serving cells, Configured downlink assignments (i.e., semi-persistent (SPS) Physical Downlink Shared Channel (PDSCH)) on one or more serving cells, Configured uplink grants (i.e., Type 1 and Type 2 Configured Grant (CG) Physical Uplink Shared Channel (PUSCH)) on one or more serving cells, PUSCH resource for semi-persistent Channel State Information (CSI) reporting on one or more serving cells.

In single TRP scenario, a TAG is defined as a group of serving cells that is configured by Radio Resource Control (RRC) and that, for the cells with a UL configured, using the same timing reference cell and the same TA value. So, a TAG has its separate TA (i.e., TA value), while each TAG (or each TA) is associated with a TAT. A TAG can be indicated by a TAG ID.

In multi-TRP scenario, a serving cell (e.g., with two TRPs) is associated with two TAGs (e.g., two TAG IDs). So, the UL transmission from UE to a TRP and the DL transmission from a TRP to UE are necessary to be associated with a TAG ID (i.e., associated with a TAG), so that they can be associated with a TA (i.e., TA value) and its associated TAT.

A first embodiment relates to association between TAG (or TAG ID) and UL transmission to a TRP of a serving cell, and association between TAG (or TAG ID) and DL transmission from a TRP of a serving cell, in single Downlink Control Information (DCI) (S-DCI) based multi-TRP.

For UL (e.g., PUSCH, PUCCH, SRS) transmission, a TAG ID can be configured in each of the TCI states used for UL transmission for a serving cell. For example, each joint TCI state in joint TCI mode and each UL TCI state in separate TCI mode are configured with a TAG ID for the UE. For ease of discussion, the joint TCI state in joint TCI mode and the UL TCI state in separate TCI mode are referred to as ‘joint or UL TCI state’ hereinafter. It means that the UL (e.g., PUSCH, PUCCH, SRS) transmission to one TRP of a serving cell by using the joint or UL TCI state is associated with the TAG indicated by the TAG ID configured to the joint or UL TCI state. Accordingly, the UL transmission to the one TRP of the serving cell is associated with the TA (i.e., TA value) and the TAT represented by the TAG.

In S-DCI based multi-TRP, two joint TCI states (e.g., a first joint TCI state and a second joint TCI state) in joint TCI mode or two UL TCI states (e.g., a first UL TCI state and a second UL TCI state) in separate TCI mode are indicated for a serving cell. That is, a first joint or UL TCI state and a second joint or UL TCI state, each of which is configured with a TAG ID, are indicated for the serving cell. The UL transmission by using the first joint or UL TCI state is associated with the TAG ID configured to the first joint or UL TCI state, and the UL transmission by using the second joint or UL TCI state is associated with the TAG ID configured to the second joint or UL TCI state.

For PUSCH transmission scheduled or activated by DCI format 0_1 or 0_2, the scheduling or activating DCI contains a “SRS resource set indicator” field that indicates the first joint or UL TCI state or the second joint or UL TCI state or both the first joint or UL TCI state and the second joint or UL TCI state. The TAG ID configured to each indicated joint or UL TCI state applies to the PUSCH transmission. For example, if both the first joint or UL TCI state and the second joint or UL TCI state are indicated, the scheduled PUSCH transmission by using the first joint or UL TCI state is associated with the TAG ID configured to the first joint or UL TCI state; and the scheduled PUSCH transmission by using the second joint or UL TCI state is associated with the TAG ID configured to the second joint or UL TCI state.

For PUSCH transmission scheduled or activated by DCI format 0_0, the TAG ID configured in the first joint or UL TCI state applies to the scheduled PUSCH transmission.

For type 1 configured grant PUSCH (CG-PUSCH), which corresponds to the PUSCH transmission configured by RRC signaling without DCI activation or DCI scheduling, one SRS resource set index value is configured in RRC signaling ConfiguredGrantConfig to indicate the first joint or UL TCI state or the second joint or UL TCI state or both the first joint or UL TCI state and the second joint or UL TCI state are used for the corresponding CG PUSCH transmission. The TAG ID configured in each indicated joint or UL TCI state applies to type 1 CG-PUSCH.

For PUCCH, a RRC parameter is configured per PUCCH resource or PUCCH resource group, where each PUCCH resource group comprises multiple PUSCH resources, to inform the UE to apply the first joint or UL TCI state or the second joint or UL TCI state or both the first joint or UL TCI state and the second joint or UL TCI state. The TAG ID configured in each applied joint or UL TCI state applies to the PUCCH transmission.

For SRS, if an SRS resource is configured or activated with a joint or UL TCI state used for the SRS transmission, the TAG ID configured in the joint or UL TCI state applies to the SRS resource.

If a periodic or semi-persistent or aperiodic SRS resource set for codebook (CB) or non-codebook (nCB) or antenna switch (AS) or an aperiodic SRS resource set for beam management is configured to follow the indicated unified TCI state, an RRC configuration can be provided to the SRS resource set to inform the UE to apply the first joint or UL TCI state or the second joint or UL TCI state. The TAG ID configured in the applied joint or UL TCI state applies to the SRS resource set.

As a whole, for each UL transmission including PUSCH transmission, PUCCH transmission and SRS transmission, the UE can apply the TAG ID configured in the joint or UL TCI state used for the UL transmission. In particular, a first TAG ID configured in the first joint or UL TCI state and/or a second TAG ID configured in the second joint or UL TCI state can be applied. If a UL transmission does not follow the unified TCI state, the base station (e.g., gNB) shall ensure that the TAG ID configured in the joint or UL TCI state configured for the UL transmission that does not follow the unified TCI state is the same as the TAG ID configured for the first or the second indicated joint or UL TCI state.

Two TAGs, i.e., a first TAG and a second TAG, can be indicated by the TAG ID configured to the first joint or UL TCI state and the second joint or UL TCI state. For example, the first TAG is indicated by the TAG ID configured to the first joint or UL TCI state; and the second TAG is indicated by the TAG ID configured to the second joint or UL TCI state. Accordingly, the detailed associations are listed as follows:

HARQ buffers for the UL transmission using the first joint or UL TCI state are associated with the first TAG; and HARQ buffers for the UL transmission using the second joint or UL TCI state are associated with the second TAG.

PUCCH transmission using the first joint or UL TCI state is associated with the first TAG; and PUCCH transmission using the second joint or UL TCI state is associated with the second TAG.

SRS transmission that follows the unified TCI state using the first joint or UL TCI state is associated with the first TAG; and SRS transmission that follows the unified TCI state using the second joint or UL TCI state is associated with the second TAG.

SRS transmission with configured TCI state is associated with the TAG indicated by the TAG ID configured to the configured TCI state.

Configured uplink grants corresponding to CG-PUSCH transmission using the first joint or UL TCI state is associated with the first TAG; and configured uplink grants corresponding to CG-PUSCH transmission using the second joint or UL TCI state is associated with the second TAG.

Similar to UL, the HARQ buffers for DL and the configured downlink assignment (SPS PDSCH) should be associated with a TAG ID.

In joint TCI mode, each joint TCI state is configured with a TAG ID. So, the TAG ID configured to each joint TCI state is the TAG ID associated with the DL transmission.

In separate TCI mode, DL TCI state is not configured with a TAG ID, while each UL TCI state is configured with a TAG ID. A simple way is to associate each DL TCI state with a UL TCI state. It means that a DL TCI state is associated with the TAG ID configured for the UL TCI state associated with the DL TCI state. In particular, in S-DCI based multi-TRP, two DL TCI states, e.g., a first DL TCI state and a second DL TCI state, and two UL TCI states, e.g., a first UL TCI state and a second UL TCI state, will be indicated for a serving cell in separate TCI mode. So, the first DL TCI state is associated with the TAG ID configured for the first UL TCI state (that indicates the first TAG); and the second DL TCI state is associated with the TAG ID configured in the second UL TCI state (that indicates the second TAG).

The detailed associations are listed as follows:

HARQ buffers for DL transmission using the first joint TCI state in joint TCI mode or the first DL TCI state in separate TCI mode (note that “joint TCI state in joint TCI mode or DL TCI state in separate TCI mode” is referred to as “joint or DL TCI state” hereinafter) are associated with the first TAG; and HARQ buffers for DL transmission using the second joint or DL TCI state are associated with the second TAG.

Configured downlink assignments corresponding to the SPS PDSCH transmission using the first joint or DL TCI state are associated with the first TAG; and configured downlink assignments corresponding to the SPS PDSCH transmission using the second joint or DL TCI state are associated with the second TAG.

A second embodiment relates to association between TAG (or TAG ID) and UL transmission to a TRP of a serving cell, and association between TAG (or TAG ID) and DL transmission from a TRP of a serving cell, in multi-DCI (M-DCI) based multi-TRP.

In M-DCI based multi-TRP, a RRC parameter coresetPoolIndex with value 0 or 1 is configured for each Control Resource Set (CORESET) for TRP differential. Each coresetPoolIndex value is indicated with a joint TCI state or a pair of DL TCI state and UL TCI state for TRP specific DL transmission and UL transmission.

The association between UL transmission and the TAG are determined by using coresetPoolIndex value. For example, the first TAG corresponds to the TAG ID configured in the joint or UL TCI state for coresetPoolIndex value 0 and the second TAG corresponds the TAG ID configured in the joint or UL TCI state for coresetPoolIndex value 1.

The PUSCH (including dynamic granted PUSCH, Type 1 CG PUSCH and Type 2 CG PUSCH) transmitted by the first SRS resource set or by the first joint or UL TCI state is associated with the first TAG; and the PUSCH (including dynamic granted PUSCH, Type 1 CG PUSCH and Type 2 CG PUSCH) transmitted by the second SRS resource set or by the second joint or UL TCI state is associated with the second TAG. Incidentally, the first joint or UL TCI state is the joint or UL TCI state specific to coresetPoolIndex value 0; and the second joint or UL TCI state is the joint or UL TCI state specific to coresetPoolIndex value 1. The first SRS resource set is associated with coresetPoolIndex value 0 and the second SRS resource set is associated with coresetPoolIndex value 1.

The PUCCH resources or resource group configured to follow the first joint or UL TCI state is associated with the first TAG; and the PUCCH resources or resource group configured to follow the second joint or UL TCI state is associated with the second TAG.

The first SRS resource set for codebook or non-codebook is associated with the first TAG; and the second SRS resource set for codebook or non-codebook is associated with the second TAG.

The periodic SRS resource set for antenna switch, semi-persistent SRS resource set for antenna switch, and aperiodic SRS for beam management or antenna switch that are indicted to follow the first joint or UL TCI state is associated with the first TAG, and periodic SRS resource set for antenna switch, semi-persistent SRS resource set for antenna switch, and aperiodic SRS for beam management or antenna switch that are indicted to follow the second joint or UL TCI state is associated with the second TAG.

For aperiodic SRS that does not follow the indicated TCI state, the SRS transmission triggered by DCI from CORESET configured with coresetPoolIndex value 0 is associated with the first TAG, and the SRS transmission triggered by DCI from the CORESET configured with coresetPoolIndex value 1 is associated with the second TAG.

The detailed associations are listed as follows:

HARQ buffers for the UL transmission using the first joint or UL TCI state specific to coresetPoolIndex value 0 is associated with the first TAG, and the HARQ buffers for the UL transmission using the second joint or UL TCI state specific to coresetPoolIndex value 1 is associated with the second TAG.

PUCCH transmission using the first joint or UL TCI state specific to coresetPoolIndex value 0 is associated with the first TAG, and PUCCH transmission using the second joint or UL TCI state specific to coresetPoolIndex value 1 is associated with the second TAG.

SRS transmission that is configured to follow the indicated TCI state, using the first joint or UL TCI state specific to coresetPoolIndex value 0, is associated with the first TAG, and SRS transmission that is configured to follow the indicated TCI state, using the second joint or UL TCI state specific to coresetPoolIndex value 1, is associated with the second TAG.

SRS transmission with configured TCI state is associated with the TAG indicated by the TAG ID configured for the configured TCI state.

Configured uplink grants corresponding to CG PUSCH transmission using the first joint or UL TCI state specific to coresetPoolIndex value 0 is associated with the first TAG; and configured uplink grants corresponding to CG-PUSCH transmission using the second joint or UL TCI state specific to coresetPoolIndex value 1 is associated with the second TAG.

Similar to UL, coresetPoolIndex value can be used to determine the association between DL HARQ and DL assignment and the TAG (or TAG ID).

HARQ buffers for DL transmission using the first joint or DL TCI state specific to coresetPoolIndex value 0 is associated with the first TAG; and the HARQ buffers for the DL transmission using the second joint or DL TCI state specific to coresetPoolIndex value 1 is associated with the second TAG.

Configured downlink assignments corresponding to the SPS PDSCH transmission using the first joint or DL TCI state specific to coresetPoolIndex value 0 is associated with the first TAG; and configured downlink assignments corresponding to the SPS PDSCH transmission using the second joint or DL TCI state specific to coresetPoolIndex value 1 is associated with the second TAG.

A third embodiment relates to TAG specific MAC operation.

Legacy TA procedure (i.e., in single TRP scenario) was specified in TS38.321 as follows:

The MAC entity shall:
1> when a timeAlignmentTimer expires:
   2> if the timeAlignmentTimer is associated with the PTAG:
      3> flush all HARQ buffers for all Serving Cells;
      3> notify RRC to release PUCCH for all Serving Cells, if configured;
      3> notify RRC to release SRS for all Serving Cells, if configured;
      3> clear any configured downlink assignments and configured uplink grants;
      3> clear any PUSCH resource for semi-persistent CSI reporting;
      3> consider all running timeAlignmentTimers as expired;
      3> maintain N_{TA} (defined in TS 38.211 [8]) of all TAGs.
   2> else if the timeAlignmentTimer is associated with an STAG, then for all Serving Cells belonging to this TAG:
      3> flush all HARQ buffers;
      3> notify RRC to release PUCCH, if configured;
      3> notify RRC to release SRS, if configured;
      3> clear any configured downlink assignments and configured uplink grants;
      3> clear any PUSCH resource for semi-persistent CSI reporting;
      3> maintain N_{TA} (defined in TS 38.211 [8]) of this TAG.

N_{TA} is a TA value for a TAG indicated by a timing advance command.

It can be seen that when a TAT expires, DL and UL transmission for one or more serving cells that at least belong to the TAG associated with this TAT are stopped. It includes but not limited to: flush all HARQ buffers for the DL and UL transmission for one or more serving cells that at least belong to the TAG associated with this TAT; notify RRC to release configured PUCCH for one or more serving cells that at least belong to the TAG associated with this TAT; notify RRC to release configured SRS for one or more serving cells that at least belong to the TAG associated with this TAT; notify RRC to release configured SRS for one or more serving cells that at least belong to the TAG associated with this TAT; and clear any PUSCH resource for semi-persistent CSI reporting for one or more serving cells that at least belong to the TAG associated with this TAT.

The MAC entity of each of the UE and the network equipment (e.g., base station, for example, gNB) stops the DL and UL transmission at its side for one or more serving cells that at least belong to the TAG for which the associated TAT expires. It means that the MAC entity of the UE flushes all HARQ buffers for the DL and UL transmission for one or more serving cells that at least belong to the TAG for which the associated TAT expires; notifies RRC to release configured PUCCH for one or more serving cells that at least belong to the TAG for which the associated TAT expires; notifies RRC to release configured SRS for one or more serving cells that at least belong to the TAG for which the associated TAT expires; and clears any PUSCH resource for semi-persistent CSI reporting for one or more serving cells that at least belong to the TAG for which the associated TAT expires; and the MAC entity of the network equipment flushes all HARQ buffers for the DL and UL transmission for one or more serving cells that at least belong to the TAG for which the associated TAT expires; notifies RRC to release configured PUCCH for one or more serving cells that at least belong to the TAG for which the associated TAT expires; notifies RRC to release configured SRS for one or more serving cells that at least belong to the TAG for which the associated TAT expires; and clears any PUSCH resource for semi-persistent CSI reporting for one or more serving cells that at least belong to the TAG for which the associated TAT expires.

In single TRP scenario, a TAG containing the SpCell of a MAC entity is referred to as Primary Timing Advance Group (PTAG), whereas the term Secondary Timing Advance Group (STAG) refers to other TAGs.

A brief introduction of SpCell is provided. When carrier aggregation (CA) is configured, the UE only has one RRC connection with the network. At RRC connection establishment, re-establishment and handover, one serving cell provides the NAS mobility information, and at RRC connection re-establishment and handover, one serving cell provides the security input. The one serving cell is referred to as the primary cell (PCell). Depending on UE capabilities, secondary cells (SCells) can be configured to form a set of serving cells together with the PCell. The configured set of serving cells for a UE consist of one PCell and one or more SCells. In case of CA, a UE has only one MAC entity. When dual connectivity (DC) is configured, the UE has two MAC entities. One MAC entity is used to connect to master cell group (MCG) which consists of a set of serving cells including a primary cell (PCell) and possibly one or more SCells. The other MAC entity is used to connect to secondary cell group (SCG) which consists of a set of serving cells including a primary secondary cell (PSCell) and possibly one or more SCells. The SpCell refers to the PCell or the PSCell.

It was agreed that when the TAT associated with one TRP of a serving cell expires, UL or DL operation associated with the other TRP of the serving cell is not impacted.

In multiple TRP scenario, a serving cell (e.g., SpCell or SCell) is associated with two TAGs.

For ease of discussion, it is assumed that the two TAGs associated with the serving cell are a first TAG and a second TAG. Each TAG is associated with a TAT. For example, the first TAG is associated with a first TAT, e.g., timeAlignmentTimer1; and the second TAG is associated with a second TAT, e.g., timeAlignmentTimer2.

When an SpCell is associated with two TAGs, the TA procedure (i.e., in multiple TRP scenario) can be enhanced with one of three options.

Option 1: The MAC entity shall:
if any one of timeAlignmentTimer1 and timeAlignmentTimer2 expires:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running timeAlignmentTimers as expired;
   maintain N_{TA} of all TAGS.

According to Option 1, each of two TAGs associated with SpCell can be regarded as a PTAG.

Option 2: The MAC entity shall:
If both timeAlignmentTimer1 and timeAlignmentTimer2 expire:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running timeAlignmentTimers as expired;
   maintain N_{TA} of all TAGS.
Else if only one of timeAlignmentTimer1 and timeAlignmentTimer2 expires (where, it is assumed that the TAG in the SpCell associated with the one TAT that expires is referred to as E-TAG),
for all other serving cells configured with a single TAG and the single TAG is E-TAG,
   flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
   maintain N_{TA} of E-TAG;
and for all serving cells (including SpCell) configured with two (or more) TAGs and one of the TAGs is E-TAG,
   flush all HARQ buffers for the DL and UL transmission associated with the one TAG (i.e., E-TAG);
   notify RRC to release PUCCH associated with the one TAG (i.e., E-TAG);
   notify RRC to release SRS associated with the one TAG (i.e., E-TAG);
   clear any configured downlink assignments and configured uplink grants associated with the one TAG (i.e., E-TAG);
   clear any PUSCH resource for semi-persistent CSI reporting associated with the one TAG (i.e., E-TAG);
   maintain N_{TA} of the one TAG (i.e., E-TAG).

According to Option 2, any of the first TAG and the second TAG associated with SpCell can be regarded as a STAG. From another point of view, the first TAG and the second TAG as a whole can be regarded as PTAG.

Option 3: One of TAGs (e.g., one of the first TAG and the second TAG) associated with SpCell is predetermined as a primary TAG (PTAG), and the other TAG is predetermined as a secondary TAG (STAG). For example, the first TAG is PTAG; and the second TAG is STAG.

The MAC entity shall:
if the TAT (e.g., timeAlignmentTimer1) associated with the primary TAG expires:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running timeAlignmentTimers as expired;
   maintain N_{TA} of all TAGS.
else if the TAT (e.g., timeAlignmentTimer2) associated with the secondary TAG expires: for all serving cells configured with a single TAG and the single TAG is the secondary TAG,
   flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
   maintain N_{TA} of the secondary TAG;
and for all serving cells (including SpCell) configured with two (or more) TAGs and one of the TAGs is the secondary TAG,
   flush all HARQ buffers for the DL and UL transmission associated with the secondary TAG;
   notify RRC to release PUCCH associated with the secondary TAG;
   notify RRC to release SRS associated with the secondary TAG;
   clear any configured downlink assignments and configured uplink grants associated with the secondary TAG;
   clear any PUSCH resource for semi-persistent CSI reporting associated with the secondary TAG;
   maintain N_{TA} of the secondary TAG.

According to Option 3, one of the TAGs (e.g., the first TAG) associated with SpCell is predetermined as PTAG, and the other TAG (e.g., the second TAG) associated with SpCell is STAG.

When two TAGs are associated with an SCell and none of the two TAGs is associated with any SpCell, the TA procedure (i.e., in multiple TRP scenario) can be enhanced as follows:

Option 4: The MAC entity shall:
if one of two TAGs (e.g., one of the first TAG and the second TAG) associated with the SCell expires (where, it is assumed that the TAG in the SCell associated with the one TAT that expires is referred to as R-TAG),
for all serving cells configured with a single TAG and the single TAG is R-TAG, flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
and for all serving cells (including SpCell) configured with two (or more) TAGs and one of the TAGs is R-TAG,
   flush all HARQ buffers for the DL and UL transmission associated with the one TAG (i.e., R-TAG);
   notify RRC to release PUCCH associated with the one TAG (i.e., R-TAG);
   notify RRC to release SRS associated with the one TAG (i.e., R-TAG);
   clear any configured downlink assignments and configured uplink grants associated with the one TAG (i.e., R-TAG);
   clear any PUSCH resource for semi-persistent CSI reporting associated with the one TAG (i.e., R-TAG);
and maintain N_{TA} of all TAGS.

In some aspects, items as examples of the disclosure concerning UE may be summarized as follows:
1. A user equipment (UE) for wireless communication, comprising:
at least one memory; and
at least one processor coupled with the at least one memory and configured to cause the UE to:
stop UL and DL transmission associated with at least one TAG associated with serving cells if TA timer(s) associated with at least one TAG expires.
2. The UE of item 1, wherein, if a TA timer associated with any one of two TAGs associated with SpCell expires, stop UL and DL transmission associated with all serving cells.
3. The UE of item 1, wherein, if both TA timers, each of which is associated with one of two TAGs associated with SpCell, expire, stop UL and DL transmission associated with all serving cells; and if only one of the two TA timers expires, stop UL and DL transmission associated with TAGs of serving cells, where each TAG of the serving cells is the same as the TAG associated with the expired TA time.
4. The UE of item 1, wherein, if a TA timer associated with a predetermined one of two TAGs associated with SpCell expires, stop UL and DL transmission associated with all serving cells; and if a TA timer associated with the other TAG associated with SpCell expires, stop UL and DL transmission associated with TAGs of serving cells, where each TAG of the serving cells is the same as the other TAG.
5. The UE of item 1, wherein, if a TA timer associated with a first TAG associated only with SCell(s) expires, stop UL and DL transmission associated with TAGs of serving cells, where each TAG of the serving cells is the same as the first TAG.
6. The UE of item 1, wherein, stop UL and DL transmission includes: flush all HARQ buffers for the DL and UL transmission; notify RRC to release configured PUCCH; notify RRC to release configured SRS; clear any configured downlink assignments and configured uplink grants; and clear any PUSCH resource for semi-persistent CSI reporting.
7. The UE of item 6, wherein, stop UL and DL transmission associated with all serving cells further includes: consider all running TA timers as expired.
8. The UE of item 1, wherein, the at least one processor is further configured to cause the UE to: associate the UL and DL transmission with one of two TAGs associated with a serving cell.
9. The UE of item 8, wherein, when S-DCI based M-TRP operation is configured for a serving cell, the UL transmission associates with one of the two TAGs according to the TAG ID configured in the joint or UL TCI state used for the UL transmission.
10. The UE of item 8, wherein, when S-DCI based M-TRP operation is configured for a serving cell, the DL transmission associates with one of the two TAGs according to the TAG ID configured in the joint TCI state used for the DL transmission or the TAG ID configured in the UL TCI state associated with the DL TCI state used for the DL transmission.
11. The UE of item 8, wherein, when M-DCI based M-TRP operation is configured for a serving cell, the UL and DL transmission associates with one of the two TAGs according to the coresetPoolIndex value associated with the TCI state used for the UL and DL transmission.
12. A processor in a UE for wireless communication, comprising:
at least one controller coupled with at least one memory and configured to cause the processor to:
stop UL and DL transmission associated with at least one TAG associated with serving cells if TA timer(s) associated with at least one TAG expires.
13. The processor of item 12, wherein, if a TA timer associated with any one of two TAGs associated with SpCell expires, stop UL and DL transmission associated with all serving cells.
14. The processor of item 12, wherein, if both TA timers, each of which is associated with one of two TAGs associated with SpCell, expire, stop UL and DL transmission associated with all serving cells; and if only one of the two TA timers expires, stop UL and DL transmission associated with TAGs of serving cells, where each TAG of the serving cells is the same as the TAG associated with the expired TA time.
15. The processor of item 12, wherein, if a TA timer associated with a predetermined one of two TAGs associated with SpCell expires, stop UL and DL transmission associated with all serving cells; and if a TA timer associated with the other TAG associated with SpCell expires, stop UL and DL transmission associated with TAGs of serving cells, where each TAG of the serving cells is the same as the other TAG.
16. The processor of item 12, wherein, if a TA timer associated with a first TAG associated only with SCell(s) expires, stop UL and DL transmission associated with TAGs of serving cells, where each TAG of the serving cells is the same as the first TAG.
17. The processor of item 12, wherein, stop UL and DL transmission includes: flush all HARQ buffers for the DL and UL transmission; notify RRC to release configured PUCCH; notify RRC to release configured SRS; clear any configured downlink assignments and configured uplink grants; and clear any PUSCH resource for semi-persistent CSI reporting.
18. The processor of item 17, wherein, stop UL and DL transmission associated with all serving cells further includes: consider all running TA timers as expired.
19. The processor of item 12, wherein, the at least one controller is further configured to cause the processor to: associate the UL and DL transmission with one of two TAGs associated with a serving cell.
20. The processor of item 19, wherein, when S-DCI based M-TRP operation is configured for a serving cell, the UL transmission associates with one of the two TAGs according to the TAG ID configured in the joint or UL TCI state used for the UL transmission.
21. The processor of item 19, wherein, when S-DCI based M-TRP operation is configured for a serving cell, the DL transmission associates with one of the two TAGs according to the TAG ID configured in the joint TCI state used for the DL transmission or the TAG ID configured in the UL TCI state associated with the DL TCI state used for the DL transmission.
22. The processor of item 19, wherein, when M-DCI based M-TRP operation is configured for a serving cell, the UL and DL transmission associates with one of the two TAGs according to the coresetPoolIndex value associated with the TCI state used for the UL and DL transmission.
23. A method performed by a user equipment (UE), the method comprising:
stopping UL and DL transmission associated with at least one TAG associated with serving cells if TA timer(s) associated with at least one TAG expires.
24. The method of item 23, wherein, if a TA timer associated with any one of two TAGs associated with SpCell expires, stopping UL and DL transmission associated with all serving cells.
25. The method of item 23, wherein, if both TA timers, each of which is associated with one of two TAGs associated with SpCell, expire, stopping UL and DL transmission associated with all serving cells; and if only one of the two TA timers expires, stopping UL and DL transmission associated with TAGs of serving cells, where each TAG of the serving cells is the same as the TAG associated with the expired TA time.
26. The method of item 23, wherein, if a TA timer associated with a predetermined one of two TAGs associated with SpCell expires, stopping UL and DL transmission associated with all serving cells; and if a TA timer associated with the other TAG associated with SpCell expires, stopping UL and DL transmission associated with TAGs of serving cells, where each TAG of the serving cells is the same as the other TAG.
27. The method of item 23, wherein, if a TA timer associated with a first TAG associated only with SCell(s) expires, stopping UL and DL transmission associated with TAGs of serving cells, where each TAG of the serving cells is the same as the first TAG.
28. The method of item 23, wherein, stopping UL and DL transmission includes: flushing all HARQ buffers for the DL and UL transmission; notifying RRC to release configured PUCCH; notifying RRC to release configured SRS; clearing any configured downlink assignments and configured uplink grants; and clearing any PUSCH resource for semi-persistent CSI reporting.
29. The method of item 28, wherein, stopping UL and DL transmission associated with all serving cells further includes: considering all running TA timers as expired.
30. The method of item 23, further comprising: associating the UL and DL transmission with one of two TAGs associated with a serving cell.
31. The method of item 30, wherein, when S-DCI based M-TRP operation is configured for a serving cell, associating the UL transmission with one of the two TAGs according to the TAG ID configured in the joint or UL TCI state used for the UL transmission.
32. The method of item 30, wherein, when S-DCI based M-TRP operation is configured for a serving cell, associating the DL transmission with one of the two TAGs according to the TAG ID configured in the joint TCI state used for the DL transmission or the TAG ID configured in the UL TCI state associated with the DL TCI state used for the DL transmission.
33. The method of item 30, wherein, when M-DCI based M-TRP operation is configured for a serving cell, associating the UL and DL transmission with one of the two TAGs according to the coresetPoolIndex value associated with the TCI state used for the UL and DL transmission.

In some other aspects, items as examples of the disclosure concerning base station may be summarized as follows:
34. A base station for wireless communication, comprising:
at least one memory; and
at least one processor coupled with the at least one memory and configured to cause the base station to:
stop UL and DL transmission associated with at least one TAG associated with serving cells if TA timer(s) associated with at least one TAG expires.
35. The base station of item 34, wherein, if a TA timer associated with any one of two TAGs associated with SpCell expires, stop UL and DL transmission associated with all serving cells.
36. The base station of item 34, wherein, if both TA timers, each of which is associated with one of two TAGs associated with SpCell, expire, stop UL and DL transmission associated with all serving cells; and if only one of the two TA timers expires, stop UL and DL transmission associated with TAGs of serving cells, where each TAG of the serving cells is the same as the TAG associated with the expired TA time.
37. The base station of item 34, wherein, if a TA timer associated with a predetermined one of two TAGs associated with SpCell expires, stop UL and DL transmission associated with all serving cells; and if a TA timer associated with the other TAG associated with SpCell expires, stop UL and DL transmission associated with TAGs of serving cells, where each TAG of the serving cells is the same as the other TAG.
38. The base station of item 34, wherein, if a TA timer associated with a first TAG associated only with SCell(s) expires, stop UL and DL transmission associated with TAGs of serving cells, where each TAG of the serving cells is the same as the first TAG.
39. The base station of item 34, wherein, stop UL and DL transmission includes: flush all HARQ buffers for the DL and UL transmission; notify RRC to release configured PUCCH; notify RRC to release configured SRS; clear any configured downlink assignments and configured uplink grants; and clear any PUSCH resource for semi-persistent CSI reporting.
40. The base station of item 39, wherein, stop UL and DL transmission associated with all serving cells further includes: consider all running TA timers as expired.
41. The base station of item 34, wherein, the at least one processor is further configured to cause the base station to: associate the UL and DL transmission with one of two TAGs associated with a serving cell.
42. The base station of item 41, wherein, when S-DCI based M-TRP operation is configured for a serving cell, the UL transmission associates with one of the two TAGs according to the TAG ID configured in the joint or UL TCI state used for the UL transmission.
43. The base station of item 41, wherein, when S-DCI based M-TRP operation is configured for a serving cell, the DL transmission associates with one of the two TAGs according to the TAG ID configured in the joint TCI state used for the DL transmission or the TAG ID configured in the UL TCI state associated with the DL TCI state used for the DL transmission.
44. The base station of item 41, wherein, when M-DCI based M-TRP operation is configured for a serving cell, the UL and DL transmission associates with one of the two TAGs according to the coresetPoolIndex value associated with the TCI state used for the UL and DL transmission.
45. A processor in a base station for wireless communication, comprising:
at least one controller coupled with at least one memory and configured to cause the processor to:
stop UL and DL transmission associated with at least one TAG associated with serving cells if TA timer(s) associated with at least one TAG expires.
46. The processor of item 45, wherein, if a TA timer associated with any one of two TAGs associated with SpCell expires, stop UL and DL transmission associated with all serving cells.
47. The processor of item 45, wherein, if both TA timers, each of which is associated with one of two TAGs associated with SpCell, expire, stop UL and DL transmission associated with all serving cells; and if only one of the two TA timers expires, stop UL and DL transmission associated with TAGs of serving cells, where each TAG of the serving cells is the same as the TAG associated with the expired TA time.
48. The processor of item 45, wherein, if a TA timer associated with a predetermined one of two TAGs associated with SpCell expires, stop UL and DL transmission associated with all serving cells; and if a TA timer associated with the other TAG associated with SpCell expires, stop UL and DL transmission associated with TAGs of serving cells, where each TAG of the serving cells is the same as the other TAG.
49. The processor of item 45, wherein, if a TA timer associated with a first TAG associated only with SCell(s) expires, stop UL and DL transmission associated with TAGs of serving cells, where each TAG of the serving cells is the same as the first TAG.
50. The processor of item 45, wherein, stop UL and DL transmission includes: flush all HARQ buffers for the DL and UL transmission; notify RRC to release configured PUCCH; notify RRC to release configured SRS; clear any configured downlink assignments and configured uplink grants; and clear any PUSCH resource for semi-persistent CSI reporting.
51. The processor of item 50, wherein, stop UL and DL transmission associated with all serving cells further includes: consider all running TA timers as expired.
52. The processor of item 45, wherein, the at least one controller is further configured to cause the processor to: associate the UL and DL transmission with one of two TAGs associated with a serving cell.
53. The processor of item 52, wherein, when S-DCI based M-TRP operation is configured for a serving cell, the UL transmission associates with one of the two TAGs according to the TAG ID configured in the joint or UL TCI state used for the UL transmission.
54. The processor of item 52, wherein, when S-DCI based M-TRP operation is configured for a serving cell, the DL transmission associates with one of the two TAGs according to the TAG ID configured in the joint TCI state used for the DL transmission or the TAG ID configured in the UL TCI state associated with the DL TCI state used for the DL transmission.
55. The processor of item 52, wherein, when M-DCI based M-TRP operation is configured for a serving cell, the UL and DL transmission associates with one of the two TAGs according to the coresetPoolIndex value associated with the TCI state used for the UL and DL transmission.
56. A method performed by a base station, the method comprising:
stopping UL and DL transmission associated with at least one TAG associated with serving cells if TA timer(s) associated with at least one TAG expires.
57. The method of item 56, wherein, if a TA timer associated with any one of two TAGs associated with SpCell expires, stopping UL and DL transmission associated with all serving cells.
58. The method of item 56, wherein, if both TA timers, each of which is associated with one of two TAGs associated with SpCell, expire, stopping UL and DL transmission associated with all serving cells; and if only one of the two TA timers expires, stopping UL and DL transmission associated with TAGs of serving cells, where each TAG of the serving cells is the same as the TAG associated with the expired TA time.
59. The method of item 56, wherein, if a TA timer associated with a predetermined one of two TAGs associated with SpCell expires, stopping UL and DL transmission associated with all serving cells; and if a TA timer associated with the other TAG associated with SpCell expires, stopping UL and DL transmission associated with TAGs of serving cells, where each TAG of the serving cells is the same as the other TAG.
60. The method of item 56, wherein, if a TA timer associated with a first TAG associated only with SCell(s) expires, stopping UL and DL transmission associated with TAGs of serving cells, where each TAG of the serving cells is the same as the first TAG.
61. The method of item 56, wherein, stopping UL and DL transmission includes: flushing all HARQ buffers for the DL and UL transmission; notifying RRC to release configured PUCCH; notifying RRC to release configured SRS; clearing any configured downlink assignments and configured uplink grants; and clearing any PUSCH resource for semi-persistent CSI reporting.
62. The method of item 61, wherein, stopping UL and DL transmission associated with all serving cells further includes: considering all running TA timers as expired.
63. The method of item 56, further comprising: associating the UL and DL transmission with one of two TAGs associated with a serving cell.
64. The method of item 63, wherein, when S-DCI based M-TRP operation is configured for a serving cell, associating the UL transmission with one of the two TAGs according to the TAG ID configured in the joint or UL TCI state used for the UL transmission.
65. The method of item 63, wherein, when S-DCI based M-TRP operation is configured for a serving cell, associating the DL transmission with one of the two TAGs according to the TAG ID configured in the joint TCI state used for the DL transmission or the TAG ID configured in the UL TCI state associated with the DL TCI state used for the DL transmission.
66. The method of item 63, wherein, when M-DCI based M-TRP operation is configured for a serving cell, associating the UL and DL transmission with one of the two TAGs according to the coresetPoolIndex value associated with the TCI state used for the UL and DL transmission.

FIG. 5 illustrates a flowchart of a method 500 in accordance with aspects of the present disclosure. The operations of the method may be implemented by a UE as described herein. In some implementations, the UE may execute a set of instructions to control the function elements of the UE to perform the described functions.

At 502, stopping UL and DL transmission associated with at least one TAG associated with serving cells if TA timer(s) associated with at least one TAG expires.

The operations of 502 may be performed in accordance with examples as described herein. In some implementations, aspects of the operations of 502 may be performed by a UE as described with reference to FIG. 2.

It should be noted that the method described herein describes a possible implementation, and that the operations and the steps may be rearranged or otherwise modified and that other implementations are possible.

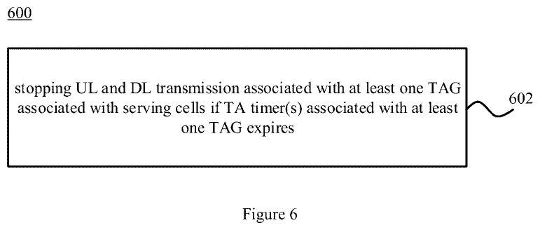

FIG. 6 illustrates a flowchart of a method 600 in accordance with aspects of the present disclosure. The operations of the method may be implemented by a NE as described herein. In some implementations, the NE may execute a set of instructions to control the function elements of the NE to perform the described functions.

At 602, stopping UL and DL transmission associated with at least one TAG associated with serving cells if TA timer(s) associated with at least one TAG expires.

The operations of 602 may be performed in accordance with examples as described herein. In some implementations, aspects of the operations of 602 may be performed by a UE as described with reference to FIG. 4.

It should be noted that the methods described herein describes possible implementations, and that the operations and the steps may be rearranged or otherwise modified and that other implementations are possible. Further, aspects from two or more of the methods may be combined.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
stop uplink (UL) and downlink (DL) transmission associated with at least one timing advance group (TAG) associated with serving cells if at least one timing advance (TA) timer associated with at least one TAG expires.

2. The UE of claim 1, wherein the at least one processor is further configured to cause the UE to, if a TA timer associated with any one of two TAGs associated with a special cell (SpCell) expires, stop UL and DL transmission associated with all serving cells.

3. The UE of claim 1, wherein the at least one processor is further configured to cause the UE to:
if two TA timers of the at least one TA timer, each of which is associated with one of two TAGs associated with a special cell (SpCell), expire, stop UL and DL transmission associated with all serving cells; and
if only one of the two TA timers expires, stop UL and DL transmission associated with TAGs of serving cells, where each TAG of the serving cells is the same as the TAG associated with the expired TA time.

4. The UE of claim 1, wherein the at least one processor is further configured to cause the UE to:
if a TA timer associated with a predetermined one of two TAGs associated with a special cell (SpCell) expires, stop UL and DL transmission associated with all serving cells; and
if a TA timer associated with a second TAG of the two TAGs associated with the SpCell expires, stop UL and DL transmission associated with TAGs of serving cells, where each TAG of the serving cells is the same as the second TAG.

5. The UE of claim 1, wherein the at least one processor is further configured to cause the UE to, if a TA timer associated with a first TAG associated only with at least one secondary cell (Scell) SCell(s) expires, stop UL and DL transmission associated with TAGs of serving cells, where each TAG of the serving cells is the same as the first TAG.

6. The UE of claim 1, wherein to stop UL and DL transmission, the at least one processor is configured to cause the UE to:
flush all hybrid automatic repeat request (HARQ) buffers for the DL and UL transmission;
notify radio resource control (RRC) to release configured physical uplink control channel (PUCCH);
notify RRC to release configured sounding reference signal (SRS);
clear any configured downlink assignments and configured uplink grants; and
clear any physical uplink shared channel (PUSCH) resource for semi-persistent channel state information (CSI) reporting.

7. The UE of claim 6, wherein to stop UL and DL transmission, the at least one processor is configured to cause the UE to: consider all running TA timers as expired.

8. The UE of claim 1, wherein the at least one processor is further configured to cause the UE to:
associate the UL and DL transmission with one of two TAGs associated with a serving cell.

9. The UE of claim 8, wherein when single downlink control information (S-DCI) based multi transmission-reception point (M-TRP) operation is configured for a serving cell, the UL transmission associates with one of two TAGs according to a TAG identifier (ID) configured in a joint or UL transmission configuration indicator (TCI) state used for the UL transmission.

10. The UE of claim 8, wherein when single downlink control information (S-DCI) based multi transmission-reception point (M-TRP) operation is configured for a serving cell, the DL transmission associates with one of the two TAGs according to a TAG identifier (ID) configured in a joint transmission configuration indicator (TCI) state used for the DL transmission or the TAG ID configured in a UL TCI state associated with the DL TCI state used for the DL transmission.

11. The UE of claim 8, wherein when multi-downlink control information (M-DCI) based multi transmission-reception point (M-TRP) operation is configured for a serving cell, the UL and DL transmission associates with one of two TAGs according to a coresetPoolIndex value associated with a transmission configuration indicator (TCI) state used for the UL and DL transmission.

12. (canceled)

13. A method performed by a user equipment (UE), the method comprising:
stopping uplink (UL) and downlink (DL) transmission associated with at least one timing advance group (TAG) associated with serving cells if at least one timing advance (TA) timer associated with at least one TAG expires.

14. A base station for wireless communication, comprising:
at least one memory; and
at least one processor coupled with the at least one memory and configured to cause the base station to:
stop uplink (UL) and downlink (DL) transmission associated with at least one timing advance group (TAG) associated with serving cells if at least one timing advance (TA) timer associated with at least one TAG expires.

15. The base station of claim 14, wherein the at least one processor is further configured to cause the base station to, if a TA timer associated with any one of two TAGs associated with a special cell (SpCell) expires, stop UL and DL transmission associated with all serving cells.

16. The base station of claim 14, wherein the at least one processor is further configured to cause the base station to, if a TA timer associated with a first TAG associated only with at least one secondary cell (Scell) expires, stop UL and DL transmission associated with TAGs of serving cells, where each TAG of the serving cells is the same as the first TAG.

17. The base station of claim 14, wherein to stop UL and DL transmission, the at least one processor is configured to cause the base station to:
flush all hybrid automatic repeat request (HARQ) buffers for the DL and UL transmission; notify radio resource control (RRC) to release configured physical uplink control channel (PUCCH); notify RRC to release configured sounding reference signal (SRS); clear any configured downlink assignments and configured uplink grants; and clear any physical uplink shared channel (PUSCH) resource for semi-persistent channel state information (CSI) reporting.

18. The method of claim 13, further comprising, if a TA timer associated with any one of two TAGs associated with a special cell (SpCell) expires, stopping UL and DL transmission associated with all serving cells.

19. The method of claim 13, wherein further comprising, if a TA timer associated with a first TAG associated only with at least one secondary cell (Scell) expires, stop UL and DL transmission associated with TAGs of serving cells, where each TAG of the serving cells is the same as the first TAG.

20. The method of claim 13, wherein stopping UL and DL transmission comprises:
flushing all hybrid automatic repeat request (HARQ) buffers for the DL and UL transmission;
notifying radio resource control (RRC) to release configured physical uplink control channel (PUCCH);
notifying RRC to release configured sounding reference signal (SRS);
clearing any configured downlink assignments and configured uplink grants; and
clearing any physical uplink shared channel (PUSCH) resource for semi-persistent channel state information (CSI) reporting.

21. A method performed by a base station, the method comprising:
stopping uplink (UL) and downlink (DL) transmission associated with at least one timing advance group (TAG) associated with serving cells if at least one timing advance (TA) timer associated with at least one TAG expires.
